(19) United States
(12) Patent Application Publication
(10) Pub. No.: US 2003/0053783 A1
(43) Pub. Date: Mar. 20, 2003

(54) Optical fiber having temperature independent optical characteristics

(76) Inventor: Masataka Shirasaki, Winchester, MA (US)

Correspondence Address: Dr. Masataka Shirasaki, Corlux Corporation, 47361 Bayside Parkway, Fremont, CA, 94538, US

(21) Appl. No.: 09/954,732

(22) Filed: Sep. 18, 2001

(51) Int. Cl. G02B 6/16; G02B 6/22

(52) U.S. Cl. 385/128; 385/127; 385/123

(57) ABSTRACT

The invention relates to apparatus and methods for reducing the temperature sensitivity of optical fibers. According to one embodiment, the temperature insensitive optical fiber includes a core having a temperature dependent optical length and a cladding surrounding the core. The temperature insensitive fiber further includes an expansion control coating substantially surrounding the cladding. The expansion control coating has a coefficient of thermal expansion and is adapted to modify the temperature dependence of the optical length. The temperature insensitive optical fiber can be used in a fiber interferometer to substantially compensate the interferometer output signal over an operating temperature range. The temperature insensitive optical fiber can also be adapted for fiber diffraction gratings.

### FIELD OF THE INVENTION

This invention relates generally to optical fibers, and more specifically to optical fibers for use in temperature insensitive fiber interferometers or temperature insensitive fiber diffraction gratings.

### BACKGROUND OF THE INVENTION

The demand for increased communication data rates necessitates a constant need for improved technologies to support that demand. One such emerging technology area is fiber optic communications, in which data is transmitted as light energy over optical fibers. To increase data rates, multiple data channels are provided over a single fiber link. For example, in wavelength division multiplexing (“WDM”), channels are differentiated by wavelength. This differentiation requires special optical components to combine and separate the different channels for transmission, switching and receiving data. In WDM systems, fiber interferometers and fiber Bragg gratings (“FBGs”) are used for filtering and dispersion control. For example, FBGs can differentiate wavelengths in multi-wavelength optical signals. Typically, a FBG is formed in an optical fiber by creating periodic longitudinal perturbations in refractive index of the core along the fiber axis. Unfortunately, FBGs generally exhibit significant temperature sensitivity. For example, the resonant wavelength of a FBG can vary as much as 0.01 nm/° C. and can degrade wavelength control available in an unstable temperature environment. Consequently, FBGs are not suitable for applications in which the environment cannot be temperature controlled.

Several temperature compensation schemes have been proposed to overcome the temperature sensitivity of a FBG. In one solution, wavelength changes resulting from application of a longitudinal strain to the optical fiber are used to compensate for wavelength changes resulting from temperature variations. This requires a complex mechanical arrangement of compensating elements with different coefficients of thermal expansion (“CTE”). By mechanically adjusting the positions of the compensating elements with respect to each other, the temperature sensitivity of the FBG is substantially reduced. Unfortunately, implementation of this configuration is complex and expensive.

In another solution, a material having a negative CTE is used for the core. The reflected wavelength of the FBG is substantially independent of temperature if the core material contracts with increasing temperature at the same rate that the refractive index of the core increases with increasing temperature. Thus, as the temperature changes, the optical length between grating elements remains constant. However, this condition necessitates a core material having a negative CTE and a refractive index that increases with increasing temperature. Materials having a negative CTE are generally expensive and difficult to produce. Additionally, it is difficult to find a single negative CTE material that suitably contracts with temperature while having the appropriate refractive index.

Another device that is used in WDM systems is a fiber interferometer which can also be sensitive to temperature. In the basic configuration of a Mach-Zehnder optical fiber interferometer, an optical signal is directed into a first optical coupler and subsequently into the two fiber arms of the interferometer. The two portions of the optical signal are combined at a second optical coupler. The interferometer output signal provided at the output port is dependent on the phase difference between the optical signals from each arm at the second optical coupler. The phase difference is a function of the optical length of each arm. The refractive indices and the physical lengths of the two fiber arms vary with temperature; thus, the optical lengths of the two fiber arms also vary with temperature. Hence, the phase difference is sensitive to temperature variations. In communication systems, the unwanted changes in the phase difference deteriorate the signal in high-bandwidth communications.

Another proposed solution involves choosing the CTE and refractive index temperature dependency for both the fiber core and the fiber cladding. The interferometer performance exhibits insignificant temperature dependence for the appropriate selection of core and cladding materials. For example, U.S. Pat. No. 5,018,827 (Brownrigg et al.) discloses a fiber including a core material and a cladding material having unequal CTEs. The radius of the cladding is determined such that an effective coefficient of thermal expansion for the fiber is substantially equal to the negative of the product of the reciprocal of the index of refraction of the core material and the temperature dependent rate of change of the index of refraction of the core material. However, materials having the required CTEs and refractive indexes are generally difficult to produce.

What is needed is a solution for eliminating the temperature sensitivity of a fiber Bragg grating or an optical fiber interferometer that does not suffer from the disadvantages of current solutions.

### SUMMARY OF THE INVENTION

In one aspect, the invention relates to a temperature stabilized optical fiber. The temperature stabilized optical fiber includes a core having a temperature dependent optical length. The fiber also includes a cladding surrounding the core. The fiber further includes an expansion control coating which substantially surrounds the cladding. The expansion control coating has a coefficient of thermal expansion and is adapted to modify the temperature dependence of the physical fiber length. In one embodiment, the modified temperature dependence of the optical length is substantially zero. In other embodiments, the expansion control coating includes glass, plastic, or other suitable material. In yet another embodiment the core has a coefficient of thermal expansion which is greater than the coefficient of thermal expansion of the expansion control coating. In another embodiment, the fiber further includes a stress relief coating disposed between the cladding and the expansion control coating. The stress relief coating can include a flexible material, a porous material, or other suitable material.

In another aspect, the invention relates to a temperature stabilized interferometer. The interferometer includes a first optical coupler having a first output port and a second output port. The interferometer also includes a first optical fiber in optical communication with the first output port. The first optical fiber includes a first core having a first temperature dependent optical length and a first cladding surrounding the first core. The first optical fiber also includes an expansion control coating which substantially surrounds the first cladding. The expansion control coating has a coefficient of thermal expansion and is adapted to modify the temperature dependence of the first optical length. The interferometer further includes a second optical fiber in optical communication with the second output port. The second optical fiber includes a second core having a second temperature dependent optical length and a second cladding surrounding the second core. The difference between the first optical length and the second optical length is substantially constant for a predetermined temperature range.

In another embodiment, the temperature stabilized interferometer further includes a stress relief coating disposed between the first cladding and the expansion control coating. In yet another embodiment, the second optical fiber further includes an expansion control coating substantially surrounding the second cladding. The expansion control coating has a coefficient of thermal expansion and is adapted to modify the temperature dependence of the second optical length. In another embodiment, the temperature stabilized interferometer further includes a stress relief coating disposed between the second cladding and the expansion control coating.

In yet another embodiment, the invention relates to a temperature stabilized fiber diffraction grating. The grating includes a core having a longitudinal refractive index profile. The longitudinal refractive index profile includes a periodic variation in refractive index and has temperature dependence. The grating includes a cladding surrounding the core and an expansion control coating substantially surrounding the cladding. The expansion control coating has a coefficient of thermal expansion and is adapted to modify the temperature dependence of the longitudinal refractive index profile. In one embodiment, the temperature stabilized fiber diffraction grating also includes a stress relief coating disposed between the cladding and the expansion control coating. In another embodiment, the periodic variation in refractive index defines a Bragg grating.

The invention also relates to a method for fabricating a temperature insensitive optical fiber. The method includes selecting a core having a temperature dependent optical length. The method also includes surrounding the core with a cladding and modifying the temperature dependence of the optical length by substantially surrounding the cladding with an expansion control coating having a coefficient of thermal expansion.

### BRIEF DESCRIPTION OF THE DRAWINGS

The above and further advantages of the invention may be better understood by referring to the following description taken in conjunction with the accompanying drawings, in which:

FIGS. 1A and 1B are schematic perspective views of embodiments of temperature-insensitive optical fibers of the present invention;

FIGS. 2A and 2B are diagrams of a Michelson fiber interferometer and a Mach-Zehnder fiber interferometer, respectively;

FIG. 3 is a graphical representation of transmission as a function of wavelength and temperature for the Mach-Zehnder fiber interferometer of FIG. 2B;

FIGS. 4A to 4C are diagrams of embodiments of a temperature-insensitive Michelson fiber interferometer, a temperature-insensitive Mach-Zehnder fiber interferometer, and two cascaded temperature insensitive Mach-Zehnder fiber interferometers respectively, of the present invention; and

FIG. 5 is a graphical representation of the index of refraction of the core in a FBG as a function of longitudinal position and temperature.

### DETAILED DESCRIPTION

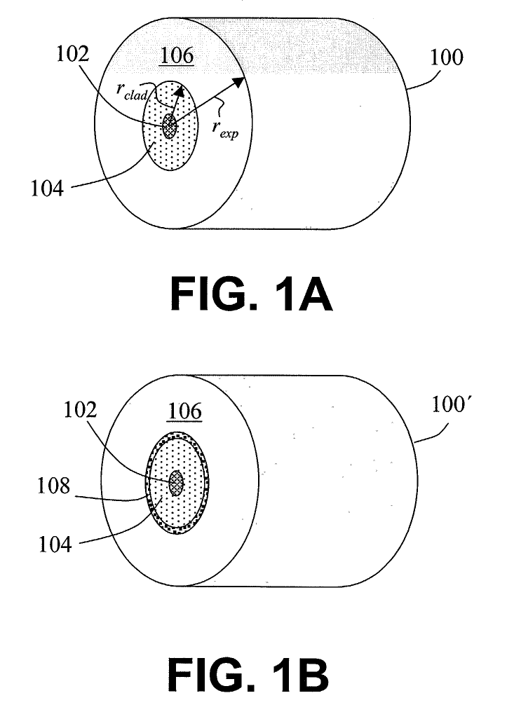

Referring to the drawings, FIG. 1A is a schematic perspective view of an embodiment of a temperature-insensitive optical fiber of the present invention. The fiber 100 includes a core 102 and a cladding 104. In one embodiment, the diameter of the core is about 9 μm and the diameter of the cladding is about 125 μm. The core 102 and cladding 104 have indices of refraction n_{core} and n_{clad}, respectively.

The core 102 is fabricated from a material having a known coefficient of thermal expansion (“CTE”) and a temperature dependent refractive index (i.e., dn_{core}/dT) not equal to zero. The core 102 has an optical length defined as the product of the physical path length of the core 102 and the refractive index n_{core} of the core 102. If the expansion control coating 106 is not present, as the temperature of the fiber varies, the core 102 expands or contracts, thereby changing its optical length. Consequently as optical length changes with temperature, the phase of the light emitted from the optical fiber changes with temperature.

In the present invention, an expansion control coating 106 surrounds the cladding 104. The expansion control coating 106 is adapted to substantially control the optical length of the core 102. The CTE of the expansion control coating 106 is different from the CTE of the core 102. The radius rₑₓₚ of the expansion control coating 106 is substantially larger than the radius r_{clad} of the cladding 104. Consequently, the volume of the expansion control coating 106 per unit length is substantially greater than the volume of the cladding 104 per unit length. Thus, the expansion of the control coating 106 is the predominant effect in the longitudinal and radial expansion of the fiber 100. As the fiber expands or contracts, the optical length increase or decreases accordingly. Thus, an expansion control coating 106 of appropriate radius, length and CTE can be used to control the temperature dependence of the optical length of the fiber 100.

As the temperature increases, the core 102 is stressed because the core 102, the cladding 104 and the expansion control coating 106 expand and contract at different rates. In one embodiment, the fiber 100′ includes a stress relief coating 108 disposed between the cladding 104 and the expansion control coating 106 as shown in FIG. 1B. The stress relief coating 108 is adapted to relieve the stress generated by the differential expansion in radius between the cladding 104 and the expansion control coating 106. The stress relief coating 108 can be fabricated from a flexible material, the volume of which can be easily changed by pressure, or a porous material, for example. The stress relief coating 108 is adapted to substantially eliminate stresses in the radial direction of the fiber core 102. Since a sheer force exists between the stress relief coating and the fiber core 102, the physical length of the fiber is substantially determined by the expansion control coating 106.

In one embodiment, as the temperature changes, the physical length of the core 102 is primarily determined by the physical length of the expansion control coating 106. For example, if the expansion control coating 106 is fabricated from a material having a large positive CTE, and the core 102 is fabricated from a material having a small CTE, the physical length of the core 102 increases at substantially the same rate as the expansion control coating 106 as the temperature increases. Conversely, if the expansion control coating 106 is fabricated from a material having a small CTE, and the core 102 is fabricated from a material having a large CTE, the physical length of the core 102 is restricted by the slower rate of expansion of the expansion control coasting 106.

Although core materials exist having negative temperature dependent refractive index (i.e., negative dn_{core}/dT), those materials typically have large positive CTEs (i.e., positive dL/dT). Examples of common materials having negative temperature dependent refractive index are Ohara glasses S-FPL51, S-FPL52, S-FPL53, S-PHM52 and S-PHM53. The temperature dependent refractive indexes of these materials vary from approximately −3×10⁻⁶ to −7×10⁻⁶ C⁻¹. However, these materials have a CTE on the order of 10×10⁻⁶ C⁻¹. Thus, even with a negative temperature dependent refractive index, the large positive CTE of the material ensures that the optical length of the core 102 increases as the temperature increases. In one embodiment, the expansion control coating 106 is fabricated from silica glass. The CTE of silica glass is approximately 0.5×10⁻⁶ C⁻¹. Thus, by choosing an appropriate material (e.g., silica) for the expansion control coating 106, an optical fiber 100 having a core 102 having a substantially temperature insensitive optical length can be produced.

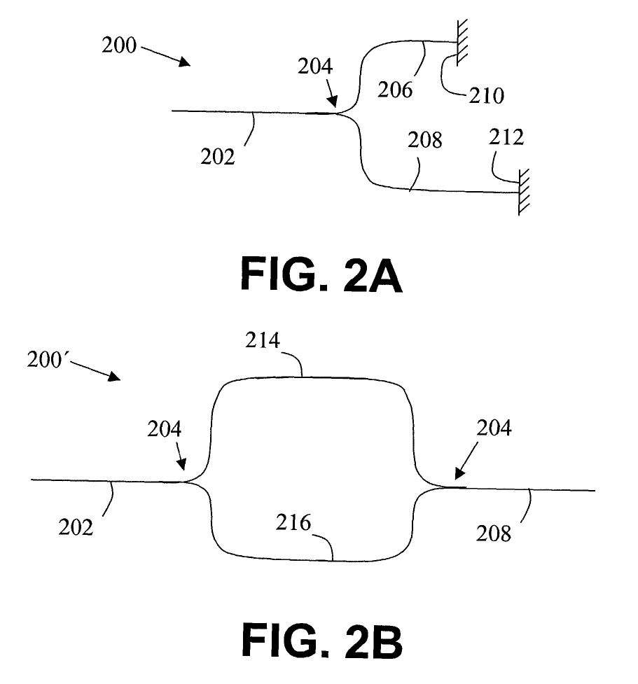

FIGS. 2A and 2B are diagrams of a single mode fiber Michelson interferometer 200 and a single mode fiber Mach-Zehnder interferometer 200′, respectively. The optical output signal provided by these fiber interferometers 200 and 200′ is dependent on the difference in the optical lengths of the two fiber arms 206, 208 and 214, 216, respectively. The Michelson interferometer 200 includes an input fiber 202, an optical coupler 204, fiber arms 206 and 208, and mirrors 210 and 212. The optical coupler 204 can be a 3-dB coupler. To ensure a stable optical output of the interferometer 200, the optical length difference between the fiber arms 206 and 208 should be substantially independent of temperature over the operating temperature range. Generally, the fiber arms 206 and 208 have different optical lengths, therefore, as the temperature changes, the optical lengths of the fiber arms 206 and 208 change at different rates if both arms are fabricated from substantially similar fiber materials. Thus, the difference in the optical lengths of the two fibers 206 and 208 is not constant as the temperature changes.

Similarly, Mach-Zehnder interferometer 200′ includes two fiber arms 214 and 216 having different optical lengths. As the temperature of the interferometer 200′ varies, the optical lengths of the fiber arms 214 and 216 change at different rates if both arms are fabricated from substantially similar fiber materials. Thus, the difference in the optical lengths of the fibers 214 and 216 is not constant as the temperature changes.

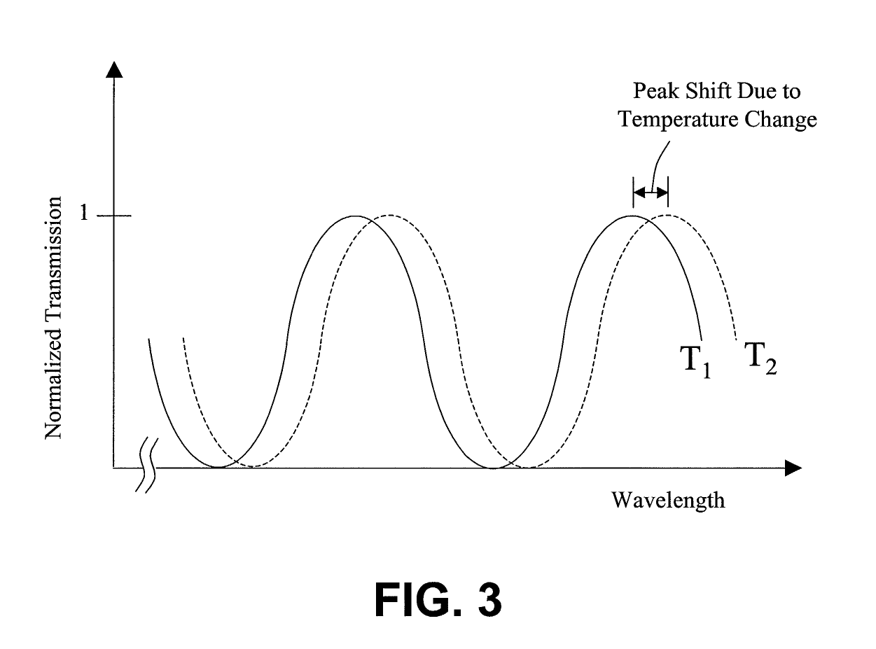

FIG. 3 is a graphical representation of normalized transmission as a function of wavelength and temperature for the Mach-Zehnder fiber interferometer 200′ of FIG. 2B. As the temperature changes from T₁ to T₂, the peaks of the transmission spectrum shift in wavelength due to the changing optical length difference of the fiber arms 214 and 216. It is one object of the invention to minimize this temperature sensitivity of the fiber interferometer 200′.

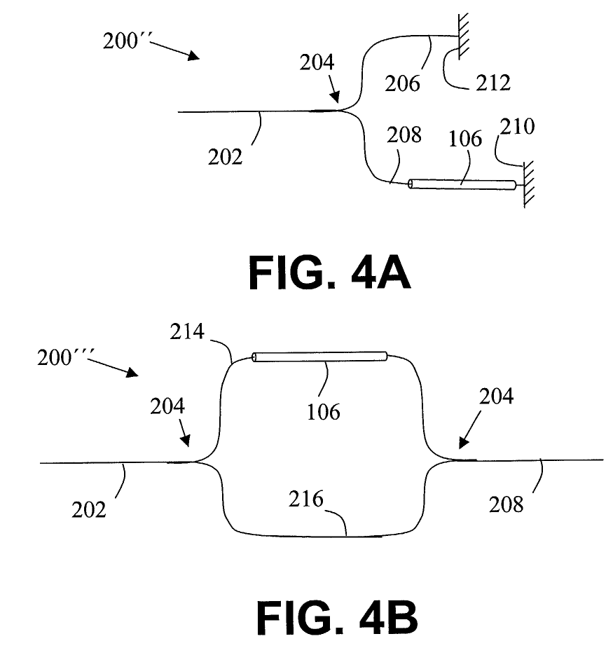

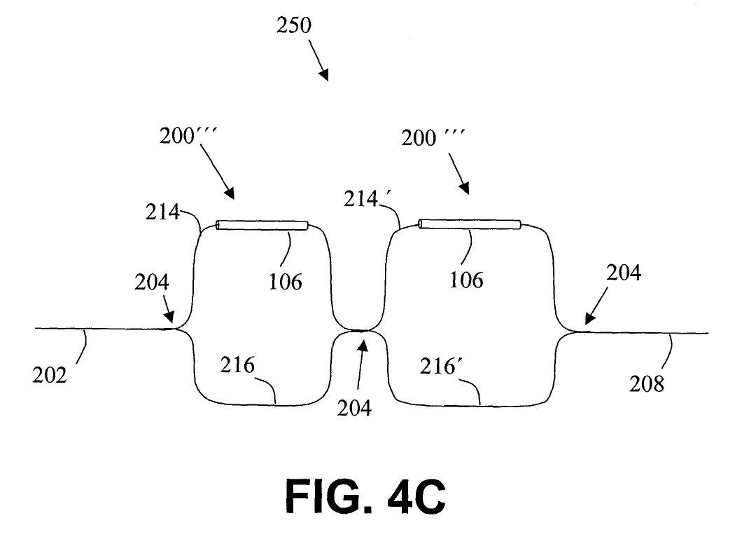

By substantially surrounding at least a portion of one arm 208 of the interferometer 200 with a suitable expansion control coating 106 as shown in FIGS. 4A and 4B, the temperature sensitivity of the interferometers 200″ and 200′″ is substantially reduced. If the fiber arms 206, 208 or 214, 216 are fabricated from the same material, they expand or contract in proportion to their arm length when subjected to the same temperature variation. Therefore, the optical length difference is temperature dependent. By including the expansion control coating 106 on a portion of the fiber arm 214, the rate of change of each optical length of the two fiber arms 214 and 216 as a function of temperature can be made substantially equal. Thus, by restraining the expansion of the longer of the arm 214 of the interferometer 200′″ such that it expands at the same rate as the shorter arm 216, the total expansion of both arms 214 and 216 can be made substantially equivalent. This essentially eliminates the temperature sensitivity of the fiber interferometer 200″. In alternative embodiments (not shown), the expansion control coating 106 is applied to at least a portion of each fiber arm 214 and 216.

One application of fiber interferometers is an interleaver filter. An interleaver filter is used to extract every other channel from a group of WDM channels. One embodiment of an interleaver filter 250 includes a plurality of cascaded interferometers 200′″ as shown in FIG. 4C. In this embodiment, each interferometer 200′″ includes at least one expansion control coating 106 applied to at least one fiber arm (e.g., 214, 214′, 216, and 216′).

Fiber diffraction gratings are used for wavelength filtering as well as chromatic dispersion management applications. One such fiber diffraction grating is a Bragg fiber grating. Fiber diffraction gratings are highly temperature dependent. A fiber diffraction grating includes a fiber having a longitudinal refractive index profile including periodic variations in refractive index along its core. The longitudinal refractive index profile varies as the temperature of the fiber changes. For example, as the fiber expands or contracts with temperature, the periodic variations in refractive index also expand or contract, affecting the characteristics of the grating. The Bragg wavelength λB of a uniform grating is given by λ_{B}=2 n_{core} Λ where n_{core} and Λ designate, respectively, an effective refractive index and the pitch of the grating. The wavelength λ_{B} of a Bragg grating under a temperature change dT is subject to a variation dλ_{B} given by dλ_{B}/dT=(α+dn_{core}/dT/n_{core})λ_{B} where α and dn_{core}/dT represent, respectively, the CTE and the temperature dependent rate of change of the refractive index of the core glass. In some Bragg fiber gratings, the Bragg wavelength λ_{B} changes by approximately 1.2 nm for a temperature change of 100° C.

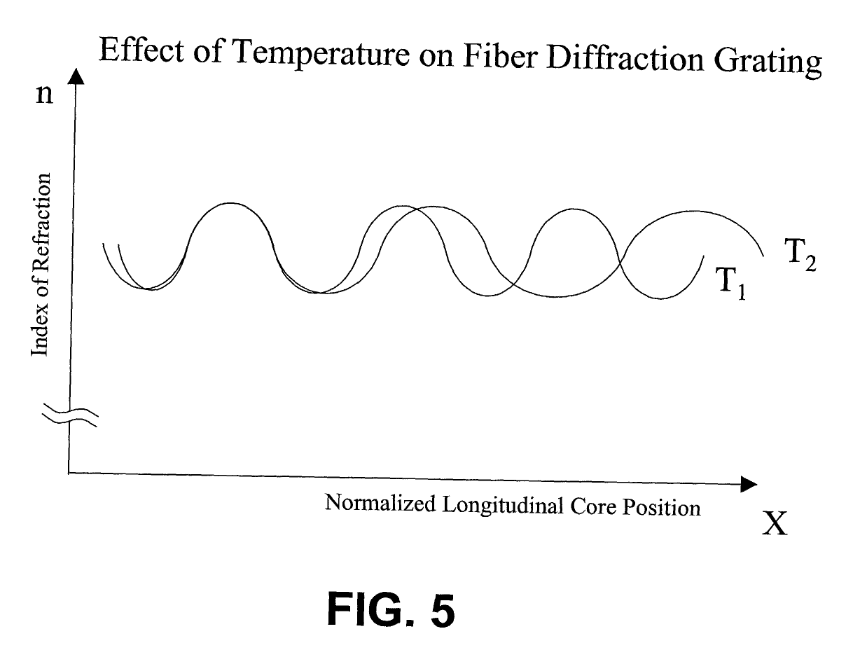

FIG. 5 illustrates the effect of temperature on a fiber diffraction grating. The longitudinal refractive index profile along the normalized longitudinal core position, which is the physical position multiplied by the index of refraction, includes a sinusoidal variation in refractive index that shifts as shown at temperature T₁ and temperature T₂. The change in temperature (T₂-T₁) causes the Bragg wavelength λ_{B} of the diffraction grating to change. Since the expansion control coating 106 provides a temperature coefficient of the optical length of the fiber, which is substantially zero, including the expansion control coating 106 along the length of the fiber in the region of the fiber diffraction grating reduces the temperature dependence of the longitudinal refractive index profile in the normalized dimension and therefore reduces the sensitivity of the Bragg wavelength λ_{B} to temperature variations.

Having described and shown the preferred embodiments of the invention, it will now become apparent to one of skill in the art that other embodiments incorporating the concepts may be used and that many variations are possible which will still be within the scope and spirit of the claimed invention. These embodiments should not be limited to disclosed embodiments but rather should be limited only by the spirit and scope of the following claims.

What is claimed as new and secured by Letters Patent is:

1. A temperature stabilized fiber, comprising:
a core having an optical length, said optical length having a temperature dependence;
a cladding surrounding said core; and
an expansion control coating substantially surrounding said cladding, said expansion control coating having a coefficient of thermal expansion and adapted to modify said temperature dependence of said optical length.

2. The temperature stabilized fiber of claim 1 wherein said modified temperature dependence of said optical length is substantially zero.

3. The temperature stabilized fiber of claim 1 wherein said expansion control coating comprises glass.

4. The temperature stabilized fiber of claim 1 wherein said expansion control coating comprises plastic.

5. The temperature stabilized fiber of claim 1 wherein said expansion control coating comprises a flexible material.

6. The temperature stabilized fiber of claim 1 wherein said core has a first coefficient of thermal expansion and said expansion control coating has a second coefficient of thermal expansion.

7. The temperature stabilized fiber of claim 6 wherein said first coefficient of thermal expansion is greater than said second coefficient of thermal expansion.

8. The temperature stabilized fiber of claim 1 further comprising a stress relief coating disposed between said cladding and said expansion control coating.

9. The temperature stabilized fiber of claim 8 wherein said stress relief coating comprises a flexible material.

10. The temperature stabilized fiber of claim 8 wherein said stress relief coating comprises a porous material.

11. The temperature stabilized fiber of claim 8 wherein a volume of said stress relief coating is modified by applying pressure to said stress relief coating.

12. A temperature stabilized interferometer, comprising:
a first optical coupler having a first output port and a second output port;
a first optical fiber in optical communication with said first output port, comprising:
a first core having a first optical length, said first optical length having a temperature dependence;
a first cladding surrounding said first core; and
an expansion control coating substantially surrounding said first cladding, said expansion control coating having a coefficient of thermal expansion and adapted to modify said temperature dependence of said first optical length; and
a second optical fiber in optical communication with said second output port, comprising:
a second core having a second optical length, said second optical length having a temperature dependence; and
a second cladding surrounding said second core;
wherein the difference between said first optical length and said second optical length is substantially constant for a predetermined temperature range.

13. The temperature stabilized interferometer of claim 12 further comprising a stress relief coating disposed between said first cladding and said expansion control coating.

14. The temperature stabilized interferometer of claim 13 wherein said stress relief coating comprises a flexible material.

15. The temperature stabilized interferometer of claim 13 wherein said stress relief coating comprises a porous material.

16. The temperature stabilized interferometer of claim 13 wherein a volume of said stress relief coating is modified by applying pressure to said stress relief coating.

17. The temperature stabilized interferometer of claim 12 further comprising a second optical coupler having a first input port in optical communication with said first optical fiber and a second input port in optical communication with said second optical fiber.

18. The temperature stabilized interferometer of claim 12 wherein said second optical fiber further comprises an expansion control coating substantially surrounding said second cladding, said expansion control coating having a coefficient of thermal expansion and adapted to modify said temperature dependence of said second optical length.

19. The temperature stabilized interferometer of claim 18 further comprising a stress relief coating disposed between said second cladding and said expansion control coating.

20. The temperature stabilized interferometer of claim 19 wherein said stress relief coating comprises a flexible material.

21. The temperature stabilized interferometer of claim 19 wherein said stress relief coating comprises a porous material.

22. The temperature stabilized interferometer of claim 19 wherein a volume of said stress relief coating is modified by applying pressure to said stress relief coating.

23. The temperature stabilized interferometer of claim 12 wherein said expansion control coating comprises glass.

24. The temperature stabilized interferometer of claim 12 wherein said expansion control coating comprises plastic.

25. The temperature stabilized interferometer of claim 12 wherein said expansion control coating comprises a flexible material.

26. The temperature stabilized interferometer of claim 17 further comprising:
a third optical fiber in optical communication with said second optical coupler, comprising:
a third core having a third optical length, said third optical length having a temperature dependence;
a third cladding surrounding said third core; and
an expansion control coating substantially surrounding said third cladding, said expansion control coating having a coefficient of thermal expansion and adapted to modify said temperature dependence of said third optical length; and
a fourth optical fiber in optical communication with said second optical coupler, comprising:
a fourth core having a fourth optical length, said fourth optical length having a temperature dependence; and
a fourth cladding surrounding said fourth core;
wherein the difference between said third optical length and said fourth optical length is substantially constant for a predetermined temperature range.

27. The temperature stabilized interferometer of claim 26 further comprising a stress relief coating disposed between said third cladding and said expansion control coating.

28. The temperature stabilized interferometer of claim 27 wherein said stress relief coating comprises a flexible material.

29. The temperature stabilized interferometer of claim 27 wherein said stress relief coating comprises a porous material.

30. The temperature stabilized interferometer of claim 27 wherein a volume of said stress relief coating is modified by applying pressure to said stress relief coating.

31. The temperature stabilized interferometer of claim 26 wherein said fourth optical fiber further comprises an expansion control coating substantially surrounding said fourth cladding, said expansion control coating having a coefficient of thermal expansion and adapted to modify said temperature dependence of said fourth optical length.

32. The temperature stabilized interferometer of claim 31 further comprising a stress relief coating disposed between said fourth cladding and said expansion control coating.

33. The temperature stabilized interferometer of claim 32 wherein said stress relief coating comprises a flexible material.

34. The temperature stabilized interferometer of claim 32 wherein said stress relief coating comprises a porous material.

35. The temperature stabilized interferometer of claim 32 wherein a volume of said stress relief coating is modified by applying pressure to said stress relief coating.

36. A temperature stabilized fiber diffraction grating, comprising:
a core having a longitudinal refractive index profile, said longitudinal refractive index profile comprising a periodic variation in refractive index;
a cladding surrounding said core; and
an expansion control coating substantially surrounding said cladding, said expansion control coating having a coefficient of thermal expansion and adapted to modify said temperature dependence of said longitudinal refractive index profile in a normalized dimension.

37. The temperature stabilized fiber diffraction grating of claim 36 further comprising a stress relief coating disposed between said cladding and said expansion control coating.

38. The temperature stabilized diffraction grating of claim 37 wherein said stress relief coating comprises a flexible material.

39. The temperature stabilized diffraction grating of claim 37 wherein said stress relief coating comprises a porous material.

40. The temperature stabilized diffraction grating of claim 37 wherein a volume of said stress relief coating is modified by applying pressure to said stress relief coating.

41. The temperature stabilized fiber diffraction grating of claim 36 wherein said core has a first coefficient of thermal expansion and said expansion control coating has a second coefficient of thermal expansion.

42. The temperature stabilized fiber diffraction grating of claim 41 wherein said first coefficient of thermal expansion is greater than said second coefficient of thermal expansion.

43. The temperature stabilized fiber diffraction grating of claim 36 wherein said expansion control coating comprises glass.

44. The temperature stabilized fiber diffraction grating of claim 36 wherein said expansion control coating comprises plastic.

45. The temperature stabilized fiber diffraction grating of claim 36 wherein said expansion control coating comprises a flexible material.

46. The temperature stabilized fiber diffraction grating of claim 36 wherein said periodic variation in refractive index defines a Bragg grating.

47. A method for fabricating a temperature insensitive fiber, comprising:
selecting a core having an optical length, said optical length having a temperature dependence;
surrounding said core with a cladding; and
modifying said temperature dependence of said optical length by substantially surrounding said cladding with an expansion control coating having a coefficient of thermal expansion.

48. A temperature stabilized optical fiber, comprising:
a means for transmitting an optical signal in an optical fiber having a temperature dependent optical length; and
a means for modifying said temperature dependence of said optical length by substantially surrounding said optical fiber with an expansion control coating having a coefficient of thermal expansion.

49. A method for reducing temperature sensitivity in a fiber interferometer, comprising:
providing an optical signal having a first portion and a second portion;
coupling said first portion of said optical signal into a first optical fiber having a first temperature dependent optical length;
modifying said temperature dependence of said first optical length by substantially surrounding said optical fiber with an expansion control coating having a coefficient of thermal expansion; and
coupling said second portion of said optical signal into a second optical fiber having a second temperature dependent optical length;
wherein the difference between said first temperature dependent optical length and said second temperature dependent optical length is substantially constant for a predetermined temperature range.

50. A temperature stabilized fiber interferometer, comprising:
a means for transmitting a first portion of an optical signal in a first optical fiber having a first temperature dependent optical length;
a means for modifying said temperature dependence of said optical length by substantially surrounding said optical fiber with an expansion control coating having a coefficient of thermal expansion; and
a means for transmitting a second portion of said optical signal in a second optical fiber having a second temperature dependent optical length;
wherein the difference between said first temperature dependent optical length and said second temperature dependent optical length is substantially constant for a predetermined temperature range.

51. A method for fabricating a temperature insensitive fiber diffraction grating, comprising:
selecting a core having a longitudinal refractive index profile, said longitudinal refractive index profile comprising a periodic variation in refractive index and having a temperature dependence;
surrounding said core with a cladding; and
modifying said temperature dependence of said longitudinal refractive index profile by substantially surrounding said cladding with an expansion control coating having a coefficient of thermal expansion.

52. A temperature stabilized fiber diffraction grating, comprising:
a means for transmitting an optical signal in an optical fiber having a temperature dependent longitudinal refractive index profile comprising a periodic variation in refractive index; and
a means for modifying said temperature dependence of said longitudinal refractive index profile by substantially surrounding said optical fiber with an expansion control coating having a coefficient of thermal expansion.
